(19) United States
(12) Patent Application Publication
(10) Pub. No.: US 2018/0109418 A1
(43) Pub. Date: Apr. 19, 2018

(54) DEVICE PROVISIONING PROTOCOL (DPP) USING ASSISTED BOOTSTRAPPING

(71) Applicant: QUALCOMM Incorporated, San Diego, CA (US)

(72) Inventors: Rosario Cammarota, San Diego, CA (US); Peerapol Tinnakornsrisuphap, San Diego, CA (US); Jouni Kalevi Malinen, Tuusula (FI)

(21) Appl. No.: 15/713,176

(22) Filed: Sep. 22, 2017

Related U.S. Application Data
(60) Provisional application No. 62/410,301, filed on Oct. 19, 2016.

(51) Int. Cl. H04L 12/24; H04L 29/06; H04L 9/08

(52) U.S. Cl. CPC H04L 41/0806; H04L 63/08; H04L 63/0435; H04L 63/12; H04L 9/0827

(57) ABSTRACT

This disclosure provides systems, methods and apparatus, including computer programs encoded on computer storage media, for enhancing a device provisioning protocol (DPP) with assisted bootstrapping. In one aspect, a configurator device can provision an enrollee device for a network with the assistance of an intermediary device. The intermediary device may obtain enrollee bootstrapping data associated with the enrollee device and send the enrollee bootstrapping data to the configurator device. The configurator device may use the enrollee bootstrapping data in an authentication process between the configurator device and the enrollee device. Following the authentication, the enrollee device may be configured by the configurator device such that the enrollee device may access a network.

### CROSS-REFERENCE TO RELATED APPLICATIONS

This Patent Application claims priority to U.S. Provisional Patent Application No. 62/410,301 filed Oct. 19, 2016, entitled “DEVICE PROVISIONING PROTOCOL USING ASSISTED BOOTSTRAPPING,” and assigned to the assignee hereof. The disclosure of the prior Application is considered part of and is incorporated by reference in this Patent Application.

### TECHNICAL FIELD

This disclosure generally relates to the field of communication systems, and, more particularly to a device provisioning protocol (DPP) in a communication network.

### DESCRIPTION OF THE RELATED TECHNOLOGY

A network is comprised of devices that communicate with each other via a communication medium. A device is configured with parameters to access the communication medium before the device can communicate with other devices of the network. The process of configuring a device may be referred to as device provisioning, and may include operations for association, enrollment, authentication, or other operations. Previous methods for provisioning a new device for a network may depend on manual entry performed by a user and may be technically complicated or difficult for the user. For example, in traditional communication systems, a user was prompted to enter security credentials. Enhanced security can be provided by using more complex security credentials. However, some users may become discouraged from using enhanced security that requires manual entry of complex security credentials or if the configuration steps are overly complicated.

### SUMMARY

The systems, methods and devices of this disclosure each have several innovative aspects, no single one of which is solely responsible for the desirable attributes disclosed herein.

One innovative aspect of the subject matter described in this disclosure can be implemented in a configurator device of a network. The configurator device may provide a configurator private signing key to an intermediary device authorized to submit an enrollment request to the configurator device. The configurator device may receive, from the intermediary device, the enrollment request signed by the configurator private signing key, the enrollment request including enrollee bootstrapping data associated with an enrollee device to be configured for the network. The configurator device may configure the enrollee device for the network. Configuring the enrollee device may include using the enrollee bootstrapping data for an authentication between the configurator device and the enrollee device.

In some implementations, the configurator device may provide the configurator private signing key using a display or short-range radio frequency interface of the configurator device.

In some implementations, the configurator device may determine a key pair for the configurator device, the key pair including the configurator private signing key and a configurator public verification key. The configurator device may verify that the enrollment request is signed by the configurator private signing key using the configurator public verification key. The configurator device may perform an enrollment of the enrollee device in response to verifying that the enrollment request is signed by the configurator private signing key.

In some implementations, the configurator device may determine a shared key for communications between the intermediary device and the configurator device. The configurator device may receive the enrollment request via a communication encrypted by the shared key. The configurator device may decrypt the communication using the shared key prior to obtaining the enrollment request. The configurator device may verify that the enrollment request is signed by the configurator private signing key prior to configuring the enrollee device for the network.

In some implementations, the enrollee bootstrapping data may include an enrollee public bootstrap key for use with a device provisioning protocol.

In some implementations, the enrollee bootstrapping data further may include at least one member selected from a group consisting of an operating class, a channel list, and a channel number.

In some implementations, the intermediary device may be a legacy device that does not natively support the device provisioning protocol. The enrollment request may be received via an application layer communication from a client application at the intermediary device.

In some implementations, the configurator device may provide configurator bootstrapping data from the configurator device to the intermediary device for the intermediary device to provide the configurator bootstrapping data to the enrollee device. The configurator device may use the configurator bootstrapping data with the enrollee bootstrapping data for the authentication between the configurator device and the enrollee device.

In some implementations, the configurator device may provide, to the intermediary device, an indication that the enrollee device has been successfully configured for the network.

Another innovative aspect of the subject matter described in this disclosure can be implemented in a configurator device for use in a network. The configurator device may include a processor and memory having instructions stored therein. The instructions, when executed by the processor cause the configurator device to provide a configurator private signing key to an intermediary device authorized to submit an enrollment request to the configurator device, receive, from the intermediary device, the enrollment request signed by the configurator private signing key, the enrollment request including enrollee bootstrapping data associated with an enrollee device to be configured for the network, and configure the enrollee device for the network. Configuring the enrollee device may include using the enrollee bootstrapping data for an authentication between the configurator device and the enrollee device.

Another innovative aspect of the subject matter described in this disclosure can be implemented in a computer-readable medium having stored therein instructions. The instructions, when executed by a processor of a configurator device of a network, may cause the configurator device to provide a configurator private signing key to an intermediary device authorized to submit an enrollment request to the configurator device, receive, from the intermediary device, the enrollment request signed by the configurator private signing key, the enrollment request including enrollee bootstrapping data associated with an enrollee device to be configured for the network, and configure the enrollee device for the network. Configuring the enrollee device may include using the enrollee bootstrapping data for an authentication between the configurator device and the enrollee device.

Details of one or more implementations of the subject matter described in this disclosure are set forth in the accompanying drawings and the following description. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example system diagram to introduce concepts of device provisioning using an intermediary device to assist with bootstrapping authentication.

FIG. 2 shows an example message flow diagram of a device provisioning protocol.

FIG. 3 shows an example system diagram to describe implementations of device provisioning using assisted bootstrapping.

FIG. 4 shows an example message flow diagram of the device provisioning protocol with assisted bootstrapping.

FIG. 5 shows a block diagram of an example configurator device.

FIG. 6 shows a block diagram of an example intermediary device.

FIG. 7 shows an example flowchart for operating the configurator device.

FIG. 8 shows an example flowchart for operating the intermediary device.

FIG. 9 shows a block diagram of an example electronic device for implementing aspects of this disclosure.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or interne of things (IOT) network, such as a system utilizing 3G, 4G or 5G, or further implementations thereof, technology.

A new device that is not yet configured for a network is referred to as an enrollee device. A device provisioning protocol (DPP) may be used to facilitate configuration of an enrollee device being introduced to the network. For example, the device provisioning protocol may provide authentication and authenticated key establishment between the enrollee device and a configurator device. A configurator device provides the configuration used by the enrollee device to join the network. Each of the enrollee device and the configurator device may have a public bootstrap key (also sometimes referred to as a “public identity key”) which is trusted between the devices and which can be used for an initial authentication. In some implementations, the public bootstrap keys are used for generating a temporary provisioning key.

When a public bootstrap key of another device is obtained using an out-of-band technique, the process of obtaining the public bootstrap key is referred to as “bootstrapping.” Bootstrapping provides trust in the public bootstrap key because the out-of-band technique typically involves proximity or physical association with the enrollee device. For example, bootstrapping may include scanning a Quick Response® (QR) code that encodes the public bootstrap key. Support for this form of authentication may allow certain devices (such as IOT devices, wearable accessories, home automation devices, etc.) that lack a user interface to be authenticated with a configurator device.

An example device provisioning protocol may be implemented between two devices that natively support the device provisioning protocol. However, device provisioning protocol may be enhanced to utilize a third device referred to as an intermediary device. The intermediary device may serve as an intermediary between the enrollee device and the configurator device. For example, the intermediary device may facilitate “bootstrapping” between the enrollee device and the configurator device. The intermediary device may obtain enrollee bootstrapping data (such as a public bootstrap key) associated with the enrollee device and send the enrollee bootstrapping data to the configurator device. The intermediary device may provide the enrollee bootstrapping data to the configurator device in an enrollment request on behalf of the enrollee device. The intermediary device may sign the enrollment request using a configurator private signing key obtained from the configurator device. The configurator device can verify the authenticity of the enrollment request using a configurator public verification key that corresponds to the configurator private signing key.

In some implementations, the intermediary device may be a legacy device. A legacy device refers to any device which is does not natively support the device provisioning protocol or which is not capable of utilizing the device provisioning protocol for its own network configuration. However, the legacy device may be capable of executing a client application which can communicate with a host service of the configurator device. Therefore, even though the legacy device does not implement the device provisioning protocol, the client application running on the legacy device can still be used to facilitate the bootstrapping of trust between the enrollee device and the configurator device.

Particular implementations of the subject matter described in this disclosure can be implemented to realize one or more of the following potential advantages. A device provisioning protocol may utilize enhanced security features while eliminating or reducing the need for manual entry by the user. For example, the use of an intermediary device may reduce or eliminate some user actions that might otherwise be performed in a device provisioning protocol. By providing a configurator private signing key to an intermediary device, the device provisioning protocol extends the trust from the configurator device to the intermediary device better suited to obtain the enrollee bootstrapping data. Modifying the device provisioning protocol to support the use of a legacy device as an intermediary device may encourage adoption of the device provisioning protocol. For example, because intermediary device may be a legacy device while still facilitating the bootstrapping process, the device provisioning protocol can be readily adopted by users having legacy devices. The use of an intermediary device to assist bootstrapping may reduce complexity and components in the configurator device. Additionally, a configurator device may support multiple intermediary devices, and thus improve scalability of a deployment, using the techniques described in this disclosure. In some implementations, an intermediary device may be coupled using a remote network while still assisting with the provisioning of devices for a network managed by the configurator device.

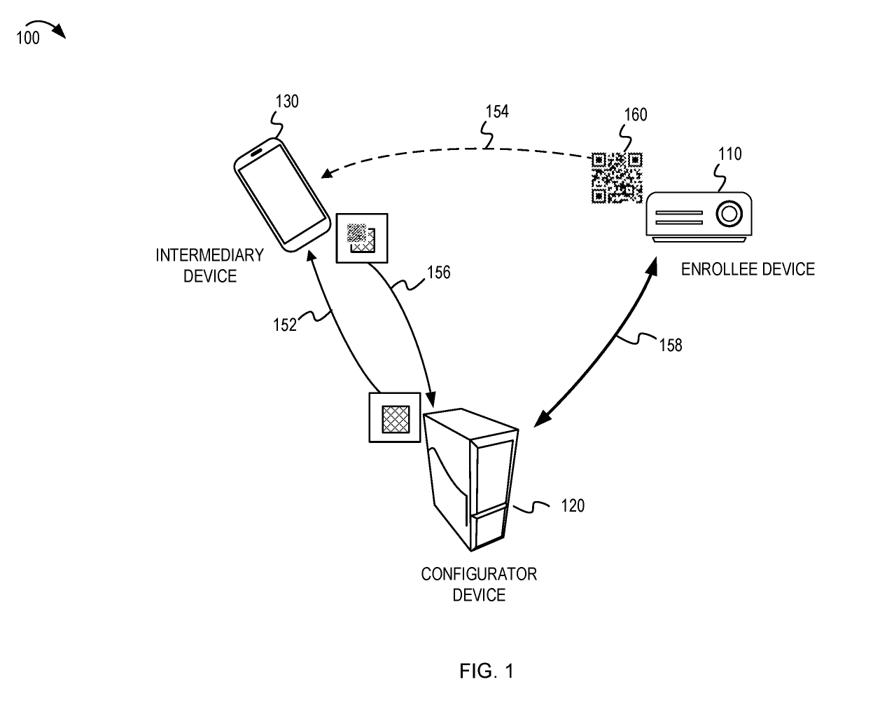

FIG. 1 shows an example system diagram to introduce concepts of device provisioning using an intermediary device to assist with bootstrapping authentication. The example system 100 includes an enrollee device 110, a configurator device 120, and an intermediary device 130. The enrollee device 110 may be any type of device which has not yet been configured for use in a network managed by the configurator device 120. In some implementations, the configurator device 120 may be a wireless local area network (WLAN) access point. In some other implementations, the configurator device 120 may be a peer-to-peer (P2P) group owner.

In some implementations, the enrollee device 110 may be a “headless” device. A device that lacks a graphical user interface may be referred to as a headless device. Examples of headless enrollee devices might include sensors, light bulbs, cameras, actuators, appliances, game controllers, audio equipment or other communication devices that are capable of communicating via the network but which may not have a graphical user interface due to design. In some implementations, the configurator device 120 may be a headless device (regardless of whether the enrollee device 110 is a headless device). An example of headless configurator devices might include an access point that does not have an integrated sensor for obtaining bootstrapping data.

The intermediary device 130 may extend the bootstrapping capabilities of the configurator device 120. For example, the configurator device 120 may not be equipped with camera, scanner, short-range radio interface, or near field communications (NFC) tag reader capabilities. Furthermore, the configurator device 120 may be mounted in a fixed position or in a hard to reach location. The intermediary device 130 may be a mobile device and may be better suited to obtain the enrollee bootstrapping data 154 of the enrollee device 110. The intermediary device 130 may be previously configured for the network using a device provisioning protocol or a legacy provisioning technique.

As shown in FIG. 1, an intermediary device 130 may assist with obtaining enrollee bootstrapping data from the enrollee device 110. In some implementations, the intermediary device 130 may be a computing device (such as a laptop, personal computer, tablet, smartphone, networked appliance, or the like). The intermediary device 130 may be communicatively coupled to configurator device 120. The configurator device 120 may provide a configurator private signing key 152 to the intermediary device 130. The configurator private signing key 152 may be encrypted to protect the credential from being obtained by another device (not shown). After obtaining the configurator private signing key 152, the intermediary device 130 may be authorized to send an enrollment request to the configurator device 120 on behalf of the enrollee device 110.

To get the enrollee device 110 configured by the configurator device 120, the intermediary device 130 may obtain enrollee bootstrapping data 154 associated with the enrollee device 110 and provide it to the configurator device 120. As shown in FIG. 1, the enrollee device 110 may have a visual tag 160 printed on it (or on the packaging, or inserted in the packaging). The visual tag 160 may be a barcode, matrix code, two-dimensional code, or the like. A common example of a barcode may be a QR code. The intermediary device 130 may detect the barcode (or similar visual tag) using a camera and corresponding software. The intermediary device 130 may obtain the enrollee bootstrapping data 154 by decoding the barcode. In some implementations, the enrollee bootstrapping data 154 may include a public bootstrap key for the enrollee device 110. In addition to the public bootstrap key, other information also may be included in the enrollee bootstrapping data 154, such as a channel list, operating class, channel number, or other information relevant to the configuration, management, or utilization of the enrollee device 110. The intermediary device 130 decodes the enrollee bootstrapping data 154.

The intermediary device 130 may sign the enrollee bootstrapping data 154 using the configurator private signing key 152. Additionally, the signed enrollee bootstrapping data 154 may be encrypted before transmission to the configurator device 120. For example, the enrollment request may be encrypted using a shared key derived based at least in part on the configurator private signing key 152. The intermediary device 130 provides the signed enrollee bootstrapping data 154 to the configurator device 120 in an enrollment message 156. The configurator device 120 may use the enrollee bootstrapping data 154 in a device provisioning protocol (shown at 158), such that the enrollee device 110 is communicatively added to the network.

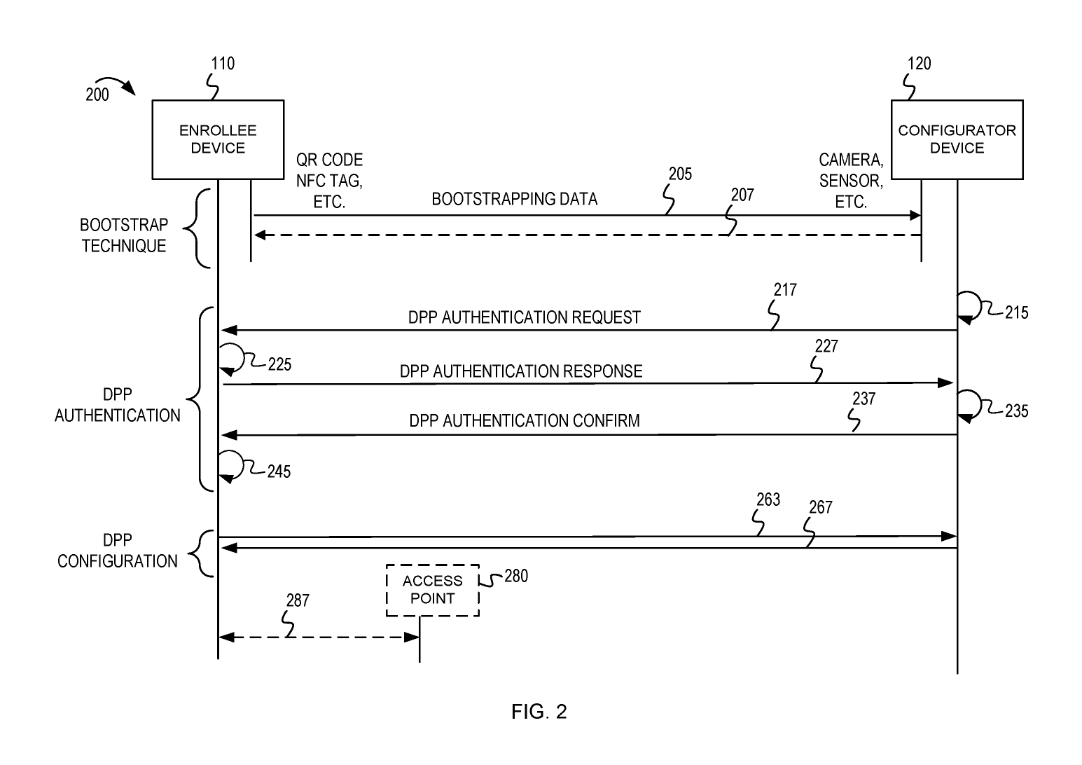

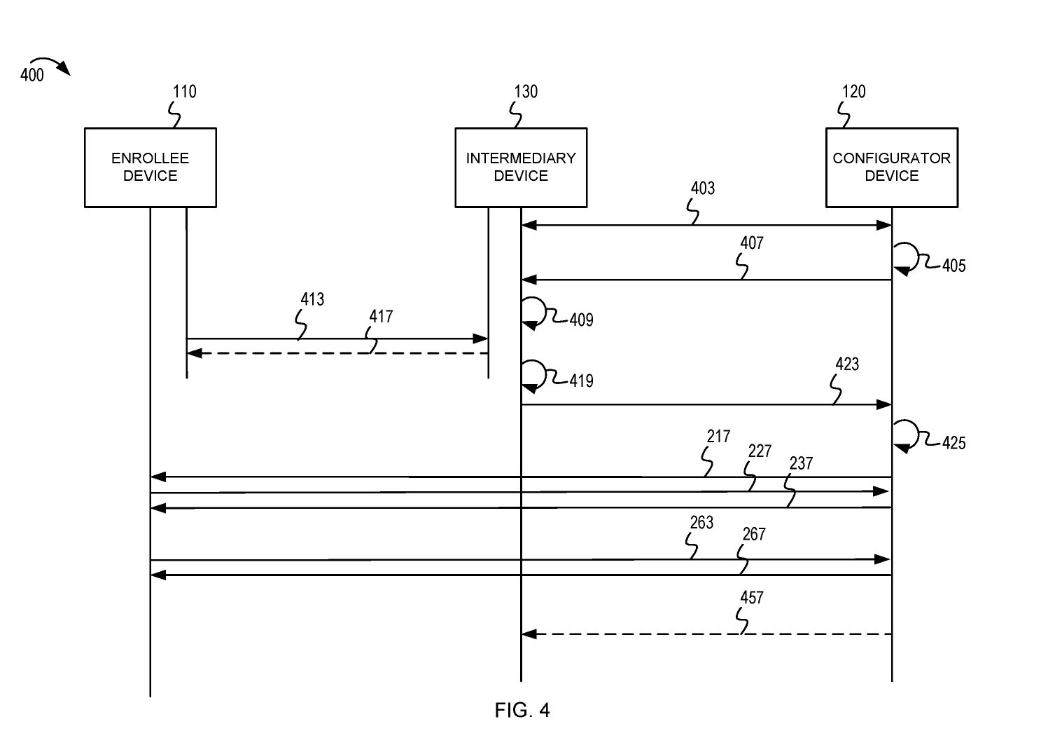

FIG. 2 shows an example message flow diagram of a device provisioning protocol. The device provisioning protocol 200 in FIG. 2 does not use the intermediary device. The example message flow described in FIG. 4 shows how the device provisioning protocol described in FIG. 2 can be modified to use the intermediary device. In FIG. 2, the device provisioning protocol 200 is between one pair of devices, the enrollee device 110 and configurator device 120, and bootstrapping is performed by the configurator device 120 directly with the enrollee device 110. In the device provisioning protocol 200, the configurator device 120 provides the configuration of the enrollee device 110. The device provisioning protocol (DPP) 200 includes three operations: the bootstrap technique, the DPP authentication, and the DPP configuration. The DPP authentication relies on the authenticating party's bootstrapping key having been obtained through the bootstrapping technique.

At 205, the configurator device 120 may obtain enrollee bootstrapping data from the enrollee device 110. The enrollee bootstrapping data may include the public bootstrap key of the enrollee device 110. In some implementations, the enrollee bootstrapping data also may include a Global Operating Class and a Channel Number list. The Global Operating Class and Channel number list may be used to determine which radio parameters or which wireless channel(s) the enrollee device 110 will use for DPP authentication. For example, together the Global Operating Class and Channel number list may indicate which wireless channel the enrollee device 110 will listen for (or send) a DPP authentication request message. At 207, in some implementations, the enrollee device 110 also may obtain a configurator bootstrapping data from the configurator device 120. When both parties obtain each other's bootstrapping data, the DPP authentication can utilize mutual bi-directional authentication.

In addition to the bootstrapping technique shown in FIG. 2, a variety of other bootstrapping techniques may be used. The bootstrapping technique allows a recipient to trust that the bootstrapping data belongs to a particular device. As described in FIG. 1, scanning a two-dimensional matrix barcode (such as a QR code) is a one technique for obtaining bootstrapping data. As an alternative to scanning a barcode, the configurator device 120 may use Neighbor-Aware Networking (NAN) (not shown). NAN provides the discovery capability and service information exchange over wireless medium without having an association between devices. Another bootstrapping technique is to transfer bootstrapping data over other media that can provide a certain amount of trust to the integrity of the transferred content (for instance USB, NFC, or Bluetooth). Yet another bootstrapping technique is to mask the bootstrapping data with a shared code (the shared code may be a key, phrase, or word used to mask the bootstrapping data, and may be referred to a code in this document). A peer may rely on knowledge of the shared code to mask or unmask the bootstrapping key. If a peer is able to prove it knows and can use the shared code, the peer's bootstrapping data can be trusted.

The DPP authentication phase uses the bootstrapping data, obtained using a bootstrapping technique, to strongly authenticate the configurator and enrollee. The DPP authentication consists of a 3-message exchange and generates a shared secret and authenticated key. At 215, the configurator device 120 generates a first nonce, generates a protocol key pair, performs a hash function of the enrollee public bootstrap key, and generates a first symmetric key based on a shared secret derived from the hashed bootstrap data. The configurator device 120 sends a DPP Authentication Request message 217 via one or more of the channels in the Channel List. The DPP authentication request message 217 includes the shared secret and the first nonce encrypted by the first symmetric key.

The enrollee device 110 receives the DPP Authentication Request message 217 and checks whether a hash of its public bootstrap key is in the message. If a hash of its public bootstrap key is in the message, the enrollee device 110 generates the shared secret and derives the first symmetric key. The enrollee device 110 attempts to unwrap the first nonce using the first symmetric key. Next, the enrollee device 110 generates a second nonce, a shared secret, and a second symmetric key. The enrollee device 110 wraps the two nonces and its capabilities in the first symmetric key and wraps the authenticating tag in the second symmetric key. The enrollee device 110 then places a hash of its public bootstrapping key (and optionally includes a hash of the configurators public bootstrapping key if it is doing mutual authentication), its public protocol key, the wrapped nonces along with its wrapped network public key and the wrapped authentication tag in an DPP Authentication Response message 227. The DPP Authentication Response message 227 is transmitted to the configurator device 120.

After receiving a response, the configurator device 120 may validate the result at 235 and transmit a DPP Authentication Confirm message 237 to complete the DPP authentication phase. After successful completion of the DPP authentication phase, a secure channel between the Initiator/Configurator and Responder/Enrollee is established.

After the DPP authentication is completed, the configurator device 120 provisions the enrollee device 110 for device-to-device communication or infrastructure communication. As part of this provisioning, the configurator device 120 enables the enrollee device 110 to establish secure associations with other peers in the network. The enrollee device 110 initiates the configuration phase by transmitting a DPP Configuration Request message 263, and is provisioned with configuration information in a DPP Configuration Response message 267. After receiving the DPP Configuration Response message 267, the enrollee device 110 is provisioned with the configuration information useable to establish secure access to the network.

In some implementations, the configurator device 120 may be an access point. Alternatively, the configurator device 120 may be separate from the access point. For example, the configuration information provided by the configurator device 120 may be used by the enrollee device 110 to establish a secure wireless connection with an access point 280. The configurator device 120 may create a “connector” (not shown). The connector is a signed introduction that enables the enrollee device 110 to get a trusted statement that other devices on the network are permitted to communicate with it. If the configurator device 120 is separate from the access point 280, the enrollee device 110 can use the configuration information and the connector as credentials for a wireless association 287 with the access point 280. The enrollee device 110 may discover the access point 280; transmit a Peer Discovery Request frame (not shown); and then wait for a Peer Discovery Response frame (not shown). Upon successful validation of the Peer Discovery frames, the enrollee device 110 and access point 280 mutually derive a pairwise master key (PMK) and follow the normal IEEE 802.11 procedures. For example, a 4-way handshake procedure may be performed between the enrollee device 110 and the access point 280 to complete authentication and wireless association of the enrollee device 110 with the access point 280. A pairwise master key (PMK) may be used for subsequent Wi-Fi™ Protected Access (WPA) handshake and configuration messages.

Alternatively, if the access point 280 is a legacy access point, the configuration information may include a pre-shared key (PSK) or a PSK Passphrase credential to allow the enrollee device 110 to connect to the access point 280. In this implementation, the enrollee device 110 will use the configuration information to discover and associate with an AP using IEEE 802.11 and WPA2-Personal network access procedures.

In this disclosure, when referring to public keys and private keys, each public key and private key may be related in a key pair. The key pair may include private and public keys which are mathematically linked but are different from each other. The public key may be used to encrypt information or to verify a digital signature. The private key may be used to decrypt the information or to create a digital signature.

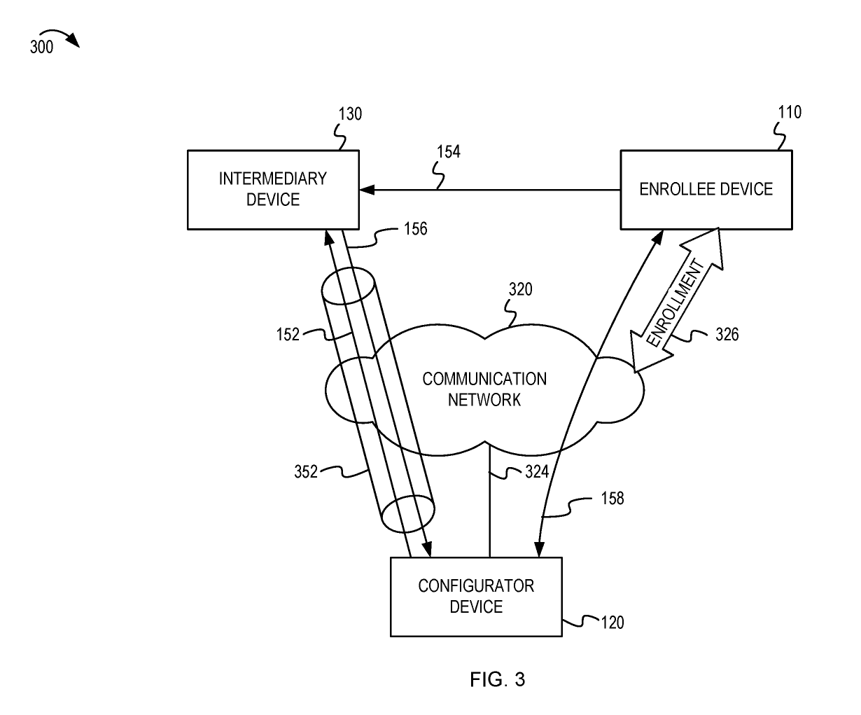

FIG. 3 shows an example system diagram to describe implementations of device provisioning using assisted bootstrapping. The example system 300 includes an enrollee device 110, a configurator device 120, and an intermediary device 130. The configurator device 120 is communicatively coupled (shown as line 324) to a communication network 320. The enrollee device 110 is a new device which is being introduced to the communication network 320 and is in need of configuration information for accessing the communication network 320. Similar to FIG. 1, the intermediary device 130 obtains enrollee bootstrapping data 154 associated with the enrollee device 110. In some implementations, the image may be static or ephemeral. For example, the enrollee device 110 may be equipped with a display and may create a different image for different instances of enrollment or for different networks. The enrollee bootstrapping data 154 can be determined by scanning and decoding the machine-readable image (such as the QR code) with a camera, smartphone, scanner, or another machine-readable code reader of the intermediary device 130.

Once the intermediary device 130 has obtained the enrollee bootstrapping data 154, the intermediary device 130 may send the enrollee bootstrapping data 154 in an enrollment message 156 to the configurator device 120. The enrollment message 156 may be signed using a configurator private signing key 152 obtained from the configurator device 120. The signature also may be based on an encryption and a signing process that proves the intermediary device 130 is authorized to send the enrollment message 156. The enrollment message 156 may include the enrollee bootstrapping data 154 and the signature, as well as other information. When the configurator device 120 receives the enrollment message 156, the configurator device 120 may verify the signature as being signed using the configurator private signing key 152 and originating from a properly authorized intermediary device 130. If the signature is verified, the configurator device 120 may use the enrollee bootstrapping data 154 from the enrollment message 156 to complete the enrollment 326 directly with the enrollee device 110. The enrollment 326 may utilize the device provisioning protocol (such as the DPP authentication and DPP configuration described in FIG. 2).

As described in this document, the configurator device 120 may have a key pair of corresponding keys: the configurator private signing key and the configurator public verification key. To provide the configurator private signing key to the intermediary device 130, the configurator device 120 may export and store the configurator private signing key. In cryptography, a family of standards called Public-Key Cryptography Standards (PKCS) is published by RSA Laboratories. PKCS #8 is one of the standards and defines a standard syntax for storing private key information. The configurator device 120 may encrypt the configurator private signing key and create an encrypted private key package using PKCS#8 to prevent the configurator private signing key from being obtained by an unauthorized intermediary device. The encryption in PCKS#8 specifies a Digital Envelope, which is composed of an Asymmetric Key Package (with all the info about the configuration) and an encryption key. The encryption key can be protected using either Key management, Key agreement, Symmetric Key derived with a shared password, or Symmetric Key Encryption through shared information. Thus, only a device which can derive the encryption key can decrypt the encrypted private key package. The configurator device 120 can create a public connector profile in the network so that any intermediary device can obtain the encrypted private key package (in the form of a PKCS#8 blob). The public connector profile may include, for example, a uniform resource locator (URL) of a network location (such as a shared drive) where the encrypted private key package can be downloaded. Although the encrypted private key package may be accessible by multiple devices, only an authorized intermediary device (such as intermediary device 130) will have the decryption information needed to decrypt the encrypted private key package. For example, the decryption information may be a shared password to derive the encryption key from the Digital Envelope associated with the encrypted private key package. Alternatively, the decryption information may be any other means for the intermediary device 130 to obtain the encryption key used to encrypt the encrypted private key package. The intermediary device 130 can download the encrypted private key package from the network location, decrypt the encrypted private key package to obtain the configurator private signing key, and store the configurator private signing key in a memory of the intermediary device 130 until it is needed to sign an enrollment request.

As described earlier, the intermediary device 130 may be a legacy device. Although the intermediary device 130 may use a traditional (non-DPP) method for associating with a network, the intermediary device 130 may be capable of executing a client application which can communicate with a host service of the configurator device. Communications between the client application (at the intermediary device 130) and the host service (at the configurator device 120) may be encrypted (shown as pipe 352). The pipe 352 may represent communications which are encrypted using a shared key, a derived key, or any other form of encryption which may precede the exchange of the configurator private signing key 152 and enrollment message 156. In some implementations, the client application and host service may perform an application-layer authentication and encryption negotiation. In some implementations, the client application and host service may use concepts from the device provisioning protocol, such as bootstrapping trust using a barcode. The client application and host service can establish a symmetric shared key or pairwise transient key (PTK) to encrypt communications through the pipe 352.

The intermediary device 130 can send the enrollee bootstrapping data (signed with configurator private signing key and, optionally, encrypted through pipe 352) via a variety of communication paths between the intermediary device 130 and the configurator device 120. For example, the intermediary device 130 may be communicatively coupled (not shown) to the communication network 320. Alternatively, the intermediary device 130 may be coupled to a remote network that is communicatively coupled to communication network 320 through one or more gateway devices. In some implementations, the intermediary device 130 may establish an encrypted pipe 352 to the configurator device 120 via the Internet. For example, an operator of the intermediary device 130 may obtain the enrollee bootstrapping data 154 from the enrollee device 110 at a remote location before the enrollee device 110 enters the communication range of the configurator device 120. The intermediary device 130 may send the enrollee bootstrapping data 154 to the configurator device 120 so that once the enrollee device 110 enters the communication range of the configurator device 120 the device provisioning protocol can be implemented without any further interaction by an operator of the enrollee device 110.

In some other implementations, the configurator device 120 may provide an indication to the intermediary device 130 regarding the device provisioning protocol process (or failure). Thus, the user of the intermediary device 130 is made aware that the configuration of the enrollee device 110 was properly completed. In some implementations, the feedback also may include an internet protocol (IP) address or other network identifier associated with the configured enrollee device 110, such that a management application on the intermediary device 130 could provide further configuration and otherwise manage or control the operation of the enrollee device 110. It may be advantageous to receive this indicator if the enrollee device 110 is a headless device because otherwise a user may be left to wonder or test through trial-and-error to determine whether the headless device has been properly added to the communication network 320.

FIG. 4 shows an example message flow diagram of the device provisioning protocol with assisted bootstrapping. The message flow diagram 400 includes messages between an enrollee device 110, an intermediary device 130 and a configurator device 120. At 403, the intermediary device 130 establishes communication with the configurator device 120. For example, the intermediary device 130 may use a legacy wireless authentication scheme to establish a wireless association with the configurator device 120. Alternatively, the intermediary device 130 and configurator device 120 may communicate with each other in a WLAN associated with a separate access point (not shown). In some other implementations, the communication between intermediary device 130 and configurator device 120 may be a peer-to-peer wireless network.

At 405, the configurator device 120 may export a configurator private signing key. The configurator private signing key may be encrypted to form a PKCS#8 encrypted private key package. The configurator private signing key may be provided in a message 407 from the configurator device 120 to the intermediary device 130. At 409, the intermediary device 130 imports the configurator private signing key and stores it for later use. At 413, the intermediary device 130 obtains enrollee bootstrapping data from the enrollee device 110. In some implementations, the intermediary device 130 also may provide configurator bootstrapping data to the enrollee device 110 to support mutual authentication in the device provisioning protocol.

At 419, the intermediary device 130 may sign the enrollee bootstrapping data using the configurator private signing key. The signed enrollee bootstrapping data is provided in an encrypted enrollment request message 423. At 425, the configurator device 120 decrypts the enrollment request message and recovers the enrollee bootstrapping data. The enrollee bootstrapping data may include an enrollee public bootstrap key used for the device provisioning protocol. Device provisioning (including authentication and configuration) can continue as described previously (see corresponding descriptions of messages 217, 227, 237, 263 and 267 in FIG. 2). For example, the enrollee public bootstrap key may be used to derive a hash value, a shared secret, and a first symmetric key for use in the DPP authentication request message 217.

After the DPP authentication and DPP configuration (represented by messages 217, 227, 237, 263, and 267), the configurator device 120 may send an indicator 457 to the intermediary device 130 to indicate that the device provisioning was successfully completed.

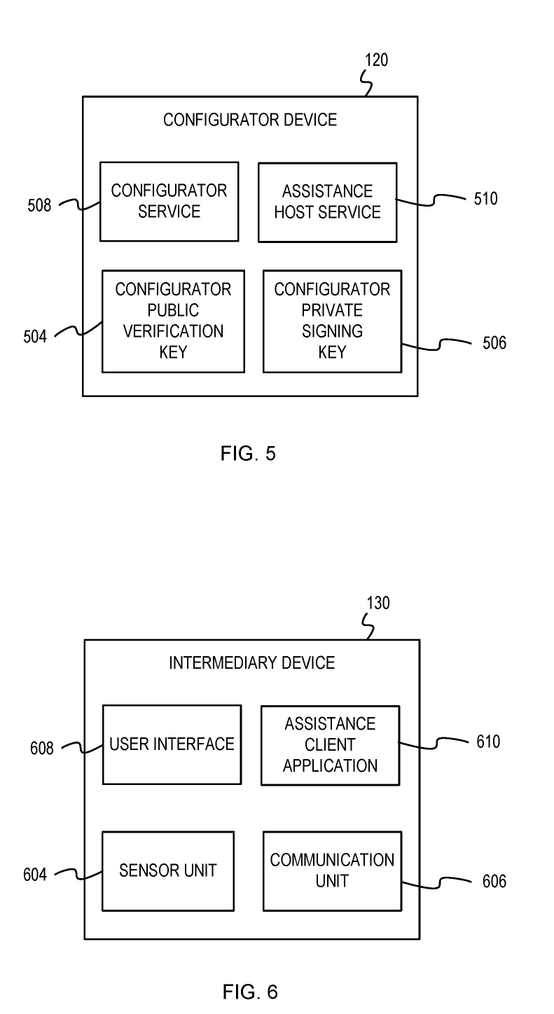

FIG. 5 shows a block diagram of an example configurator device. The configurator device 120 may include a configurator service 508, an assistance host service 510, a configurator public verification key 504, and a configurator private signing key 506. The configurator device 120 may send the configurator private signing key 506 to an intermediary device. For example, the assistance host service 510 may send the configurator private signing key 506 to a client application at the intermediary device. The assistance host service 510 may receive and process an enrollment request from the intermediary device. The enrollment request may be signed by the configurator private signing key 506 and may include enrollee bootstrapping data associated with the enrollee device. To authenticate the enrollment request, the assistance host service 510 may verify the enrollment request using the configurator public verification key 504. For example, the configurator private signing key 506 and the configurator public verification key 504 may form a key pair. The configurator device can verify that the enrollment request is signed by the configurator private signing key 506 using the configurator public verification key 504. After verifying the enrollment request, the configurator service 508 may implement the device provisioning protocol to configure the enrollee device using the enrollee bootstrapping data.

FIG. 6 shows a block diagram of an example intermediary device. The intermediary device 130 includes a sensor unit 604, a communication unit 606, a user interface 608, and an assistance client application 610. The sensor unit 604 can detect or decode the enrollee bootstrapping data associated with the enrollee device. For example, the sensor unit 604 may be a camera, NFC interface, photo sensor, barcode scanner, microphone, or other such components capable of detecting the enrollee bootstrapping data associated with the enrollee device. The assistance client application 610 can communicate the enrollee bootstrapping data to a configurator device using a message transmitted via the communication unit 606. In some implementations, the intermediary device may sign the enrollee bootstrapping data using a configurator private signing key received from the configurator device.

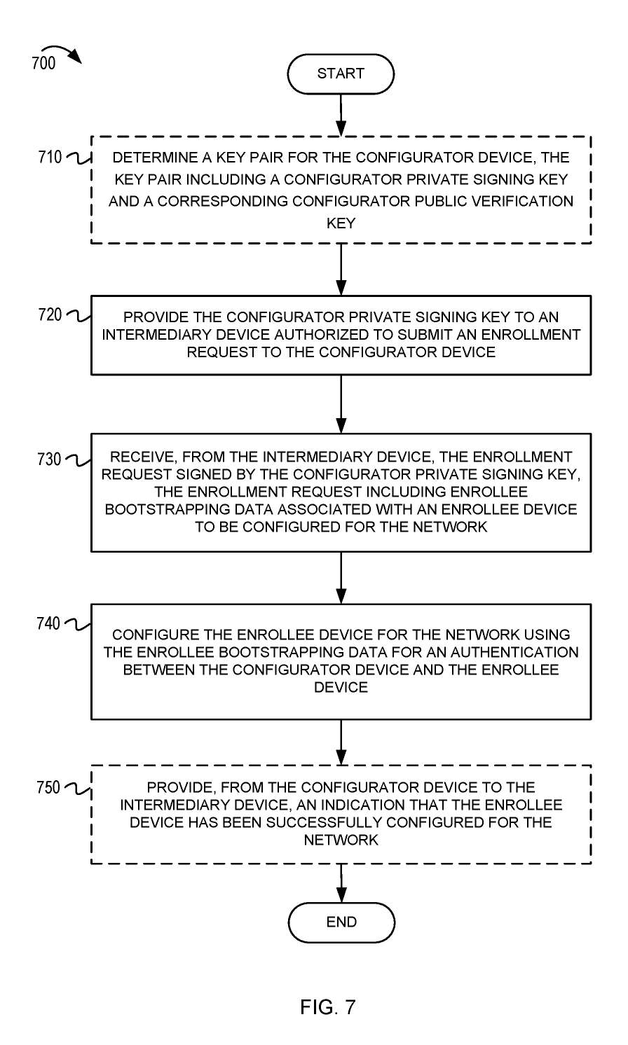

FIG. 7 shows an example flowchart for operating the configurator device. The flowchart 700 begins at block 710. At block 710, in some implementations, the configurator device may determine a key pair including a configurator private signing key and a corresponding configurator public verification key. At block 720, the configurator device may provide the configurator private signing key to an intermediary device authorized to submit an enrollment request to the configurator device. At block 730, the configurator device may receive, from the intermediary device, the enrollment request signed by the configurator private signing key. The enrollment request includes enrollee bootstrapping data associated with an enrollee device to be configured for the network. At block 740, the configurator device may configure the enrollee device for the network using the enrollee bootstrapping data for an authentication between the configurator device and the enrollee device. At block 750, in some implementations, the configurator device may provide, to the intermediary device, an indication that the enrollee device has been successfully configured for the network.

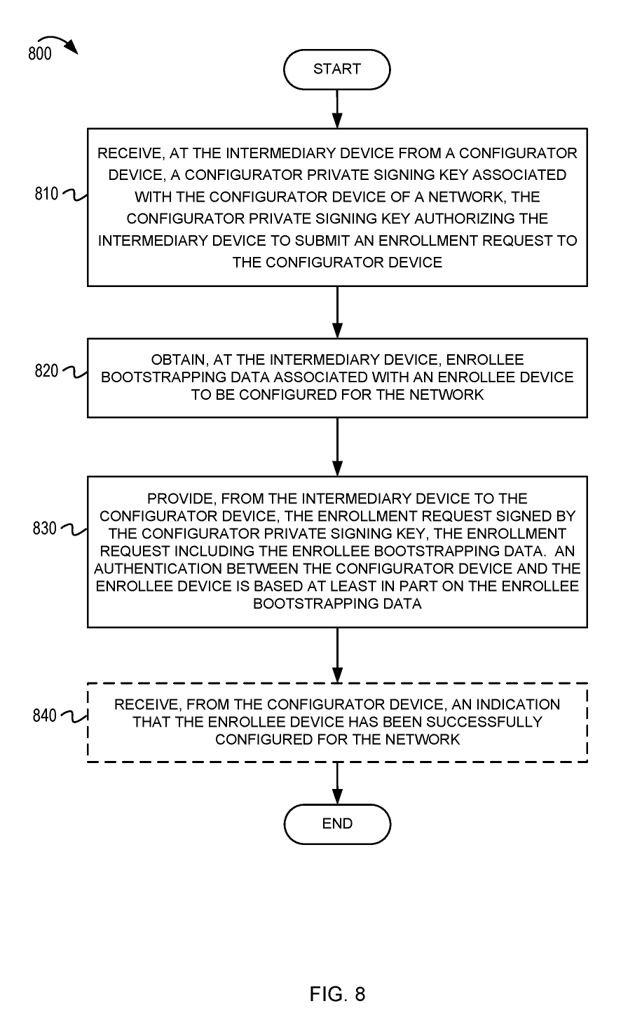

FIG. 8 shows an example flowchart for operating the intermediary device. The flowchart 800 begins at block 810. At block 810, the intermediary device may receive, from a configurator device, a configurator private signing key associated with a configurator device of a network. Having the configurator private signing key authorizes the intermediary device submit an enrollment request to the configurator device.

At block 820, the intermediary device may obtain enrollee bootstrapping data associated with an enrollee device to be configured for the network. For example, the intermediary device may obtain the enrollee bootstrapping data using a camera, microphone, light detector, scanner, short-range radio frequency interface or another sensor of the intermediary device. In some implementations, the method used to determine the enrollee bootstrapping data may involve proximity between the intermediary device and the enrollee device, to protect from unintended remote access or security breach.

At block 830, the intermediary device may provide, from the intermediary device to the configurator device, the enrollment request signed by the configurator private signing key, the enrollment request including the enrollee bootstrapping data. An authentication between the configurator device and the enrollee device is based at least in part on the enrollee bootstrapping data.

At block 840, in some implementations, the intermediary device can receive, from the configurator device, an indication that the enrollee device has been successfully configured for the network. For example, the intermediary device may present user feedback via a user interface or via the client application. The user feedback may inform the user whether or not the enrollee device has been properly added to the communication network. The user feedback may be an audible tone or tones that are recognized as either positive or negative, to reflect successful or unsuccessful enrollment, respectively. Alternatively, the user feedback may be a visual indicator or detailed information, such as in a graphical user interface available on the intermediary device.

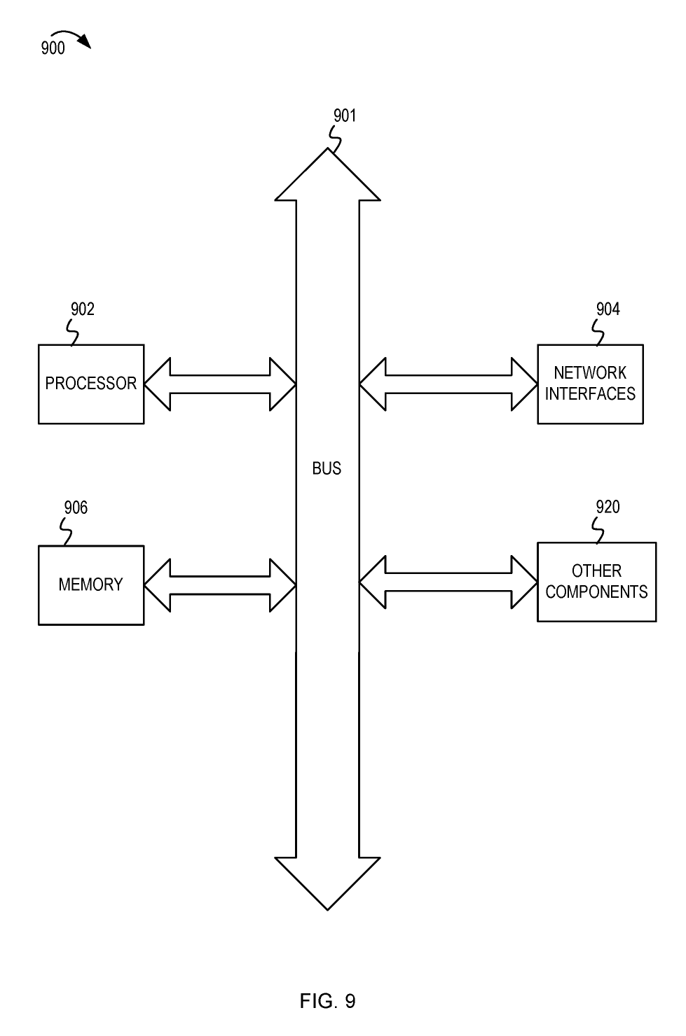

FIG. 9 shows a block diagram of an example electronic device 900 for implementing aspects of this disclosure. In some implementations, the electronic device 900 may be an enrollee device, an intermediary device, or a configurator device. The electronic device 900 may be a laptop computer, a tablet computer, a mobile phone, a gaming console, a smartwatch, a virtual or augmented reality device, a drone, or other electronic system. The electronic device 900 includes a processor 902 (possibly including multiple processors, multiple cores, multiple nodes, or implementing multi-threading, etc.). The electronic device 900 includes a memory 906. The memory 906 may be system memory or any one or more of the possible realizations of machine-readable media described in this document. The electronic device 900 also may include a bus 901 (such as PCI, ISA, PCI-Express, HyperTransport®, InfiniBand®, NuBus®, AHB, AXI, etc.). The electronic device may include one or more network interfaces 904, which may be a wireless network interface (such as a WLAN interface, a Bluetooth® interface, a WiMAX® interface, a ZigBee® interface, a Wireless USB interface, etc.) or a wired network interface (such as a powerline communication (PLC) interface, an Ethernet interface, etc.). In some implementations, electronic device 900 may support multiple network interfaces 904—each of which may be configured to couple the electronic device 900 to a different communication network.

The memory 906 includes functionality to support various implementations described in this document. The memory 906 may include one or more functionalities that facilitate assisted bootstrapping, authentication, and configuration. For example, memory 906 can implement one or more aspects of enrollee device 110, configurator device 120, or intermediary device 130 described in this document. The memory 906 can include functionality to enable implementations described in FIGS. 1-8. In some implementations, memory 906 can include one or more functionalities that facilitate sending and receiving a configurator private signing key, enrollee bootstrapping data, authentication messages, and the like. The electronic device 900 also may include other components 920, such as a sensor unit, user interface components, or another input/output component. In some other implementations, electronic device 900 may have other appropriate sensors (such as a camera, microphone, NFC detector, bar code scanner, etc.) used to determine the configurator private signing key or the enrollee bootstrapping data.

Any one of these functionalities may be partially (or entirely) implemented in hardware, such as on the processor 902. For example, the functionality may be implemented with an application specific integrated circuit, in logic implemented in the processor 902, in a co-processor on a peripheral device or card, etc. Further, realizations may include fewer or additional components not illustrated in FIG. 9 (such as video cards, audio cards, additional network interfaces, peripheral devices, etc.). The processor 902, and the memory 906, may be coupled to the bus 901. Although illustrated as being coupled to the bus 901, the memory 906 may be directly coupled to the processor 902.

The scope of this disclosure may include subject matter beyond the scope of the claims. For example, there may be claims directed to the configurator device, the intermediary device, or another device that can assist with bootstrapping for a device provisioning protocol.

One innovative aspect of the subject matter described in this disclosure can be implemented in an intermediary device. The intermediary device may receive from a configurator device, a configurator private signing key associated with the configurator device of a network. The configurator private signing key may authorize the intermediary device to submit an enrollment request to the configurator device. The intermediary device may obtain enrollee bootstrapping data associated with an enrollee device to be configured for the network. The intermediary device may provide, from the intermediary device to the configurator device, the enrollment request signed by the configurator private signing key. The enrollment request may include the enrollee bootstrapping data, where an authentication between the configurator device and the enrollee device may be based at least in part on the enrollee bootstrapping data.

In some implementations, the intermediary device may receive the configurator private signing key using a display or short-range radio frequency interface of the intermediary device.

In some implementations, the intermediary device may determine a shared key for communications between the intermediary device and the configurator device. The intermediary device may encrypt the enrollment request using the shared key.

In some implementations, prior to receiving the configurator private signing key, the intermediary device may establish a wireless association with the configurator device using a legacy configuration protocol different from a device provisioning protocol that uses a bootstrapping authentication.

In some implementations, the intermediary device may obtain, via a sensor of the intermediary device, sensor information that may be indicative of the enrollee bootstrapping data. The sensor may include at least one of a camera, a microphone, a light detector, a photo sensor, a radio frequency identifier tag reader, a near-field communications (NFC) tag sensor, a short range radio frequency communications component, and an electromagnetic sensor.

In some implementations, the intermediary device may capture, using a camera of the intermediary device, an image having the enrollee bootstrapping data associated with the enrollee device encoded. The the image may be a barcode or a Quick Response (QR) code image.

In some implementations, the enrollee bootstrapping data may include an enrollee public bootstrap key for use with a device provisioning protocol.

In some implementations, the enrollee bootstrapping data may further include at least one of an operating class, a channel list, and a channel number.

In some implementations, the intermediary device may receive configurator bootstrapping data from the configurator device. The intermediary device may provide the configurator bootstrapping data to the enrollee device. The configurator bootstrapping data may be used with the enrollee bootstrapping data for the authentication between the configurator device and the enrollee device.

In some implementations, the intermediary device may receive, from the configurator device, an indication that the enrollee device has been successfully configured for the network.

In some implementations, the enrollee device may be a new client to be configured for the network, the configurator device may be an access point of the network, and the intermediary device may be an existing client of the network.

In some implementations, the configurator device may be a headless device.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described throughout this document. Whether such functionality is implemented in hardware or software depends on the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray™ disc where disks usually reproduce data magnetically, while discs reproduce data optically with lasers. Combinations also can be included within the scope of computer-readable media. Additionally, the operations of a method or algorithm may reside as one or any combination or set of codes and instructions on a machine-readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method performed by a configurator device of a network, comprising:
providing a configurator private signing key to an intermediary device authorized to submit an enrollment request to the configurator device;
receiving, from the intermediary device, the enrollment request signed by the configurator private signing key, the enrollment request including enrollee bootstrapping data associated with an enrollee device to be configured for the network; and
configuring the enrollee device for the network, wherein configuring the enrollee device includes using the enrollee bootstrapping data for an authentication between the configurator device and the enrollee device.

2. The method of claim 1, wherein providing the configurator private signing key includes providing the configurator private signing key using a display or short-range radio frequency interface of the configurator device.

3. The method of claim 1, further comprising:
determining a key pair for the configurator device, the key pair including the configurator private signing key and a configurator public verification key;
verifying that the enrollment request is signed by the configurator private signing key using the configurator public verification key; and
performing an enrollment of the enrollee device in response to verifying that the enrollment request is signed by the configurator private signing key.

4. The method of claim 1, wherein receiving the enrollment request includes:
determining a shared key for communications between the intermediary device and the configurator device;
receiving the enrollment request via a communication encrypted by the shared key;
decrypting the communication using the shared key prior to obtaining the enrollment request; and
verifying that the enrollment request is signed by the configurator private signing key prior to configuring the enrollee device for the network.

5. The method of claim 1, wherein the enrollee bootstrapping data includes an enrollee public bootstrap key for use with a device provisioning protocol.

6. The method of claim 5, wherein the enrollee bootstrapping data further includes at least one member selected from a group consisting of an operating class, a channel list, and a channel number.

7. The method of claim 5,
wherein the intermediary device is a legacy device that does not natively support the device provisioning protocol, and
wherein the enrollment request is received via an application layer communication from a client application at the intermediary device.

8. The method of claim 1, further comprising:
providing configurator bootstrapping data from the configurator device to the intermediary device for the intermediary device to provide the configurator bootstrapping data to the enrollee device; and
using the configurator bootstrapping data with the enrollee bootstrapping data for the authentication between the configurator device and the enrollee device.

9. The method of claim 1, wherein configuring the enrollee device includes:
providing configuration data from the configurator device to the enrollee device after using the enrollee bootstrapping data for the authentication between the configurator device and the enrollee device.

10. The method of claim 1, further comprising:
providing, from the configurator device to the intermediary device, an indication that the enrollee device has been successfully configured for the network.

11. A configurator device for use in a network, comprising:
a processor; and
memory having instructions stored therein which, when executed by the processor cause the configurator device to:
provide a configurator private signing key to an intermediary device authorized to submit an enrollment request to the configurator device;
receive, from the intermediary device, the enrollment request signed by the configurator private signing key, the enrollment request including enrollee bootstrapping data associated with an enrollee device to be configured for the network; and
configure the enrollee device for the network, wherein configuring the enrollee device includes using the enrollee bootstrapping data for an authentication between the configurator device and the enrollee device.

12. The configurator device of claim 11, wherein the instructions, when executed by the processor, further cause the configurator device to:
determine a key pair for the configurator device, the key pair including the configurator private signing key and a configurator public verification key;
verify that the enrollment request is signed by the configurator private signing key using the configurator public verification key; and
perform an enrollment of the enrollee device in response to verifying that the enrollment request is signed by the configurator private signing key.

13. The configurator device of claim 11, wherein the instructions to receive the enrollment request include the instructions that, when executed by the processor, cause the configurator device to:
determine a shared key for communications between the intermediary device and the configurator device;
receive the enrollment request via a communication encrypted by the shared key;
decrypt the communication using the shared key prior to obtaining the enrollment request; and
verify that the enrollment request is signed by the configurator private signing key prior to configuring the enrollee device for the network.

14. The configurator device of claim 11, wherein the enrollee bootstrapping data includes an enrollee public bootstrap key for use with a device provisioning protocol.

15. The configurator device of claim 14,
wherein the intermediary device is a legacy device that does not natively support the device provisioning protocol, and
wherein the enrollment request is received via an application layer communication from a client application at the intermediary device.

16. The configurator device of claim 11, wherein the instructions, when executed by the processor, further cause the configurator device to:
provide configurator bootstrapping data from the configurator device to the intermediary device for the intermediary device to provide the configurator bootstrapping data to the enrollee device; and
use the configurator bootstrapping data with the enrollee bootstrapping data for the authentication between the configurator device and the enrollee device.

17. A computer-readable medium having stored therein instructions which, when executed by a processor of a configurator device of a network, cause the configurator device to:
provide a configurator private signing key to an intermediary device authorized to submit an enrollment request to the configurator device;
receive, from the intermediary device, the enrollment request signed by the configurator private signing key, the enrollment request including enrollee bootstrapping data associated with an enrollee device to be configured for the network; and
configure the enrollee device for the network, wherein configuring the enrollee device includes using the enrollee bootstrapping data for an authentication between the configurator device and the enrollee device.

18. The computer-readable medium of claim 17, wherein the instructions, when executed by the processor, further cause the configurator device to:
determine a key pair for the configurator device, the key pair including the configurator private signing key and a configurator public verification key;
verify that the enrollment request is signed by the configurator private signing key using the configurator public verification key; and
perform an enrollment of the enrollee device in response to verifying that the enrollment request is signed by the configurator private signing key.

19. The computer-readable medium of claim 17, wherein the instructions to receive the enrollment request include the instructions that, when executed by the processor, cause the configurator device to:
determine a shared key for communications between the intermediary device and the configurator device;
receive the enrollment request via a communication encrypted by the shared key;
decrypt the communication using the shared key prior to obtaining the enrollment request; and
verify that the enrollment request is signed by the configurator private signing key prior to configuring the enrollee device for the network.

20. The computer-readable medium of claim 17, wherein the instructions, when executed by the processor, further cause the configurator device to:
provide configurator bootstrapping data from the configurator device to the intermediary device for the intermediary device to provide the configurator bootstrapping data to the enrollee device; and
use the configurator bootstrapping data with the enrollee bootstrapping data for the authentication between the configurator device and the enrollee device.
